(19) United States
(12) Patent Application Publication
(10) Pub. No.: US 2008/0077749 A1
(43) Pub. Date: Mar. 27, 2008

(54) Access control of memory space in microprocessor systems

(76) Inventor: Daniel Scott Cohen, Baltimore, MD (US)

Correspondence Address: SAWYER LAW GROUP LLP, P O BOX 51418, PALO ALTO, CA, 94303, US

(21) Appl. No.: 11/525,748

(22) Filed: Sep. 22, 2006

(51) Int. Cl. G06F 12/14

(52) U.S. Cl. 711/152

(57) ABSTRACT

A system, computer program product, and method for controlling access to a system memory space are provided. The system includes a processor operable to perform an operation on the memory space and a bus monitor operable to monitor the processor. The bus monitor includes a definition for specifying the operation as either permissible or impermissible for a region of the memory space. The bus monitor is further operable to block the processor from performing the operation in response to the definition specifying the operation as impermissible.

### FIELD OF THE INVENTION

The present invention relates generally to microprocessor systems. More particularly, the present invention is directed to access control of memory space in microprocessor systems.

### BACKGROUND OF THE INVENTION

Silicon densities are now at a point where systems-on-chip (SoCs) can truly be supported. At this design level, busing systems are needed to interconnect the various components of the system, such as microprocessors, memory, peripherals, special logic, etc. One popular on-chip busing solution used in microprocessor systems with a Reduced Instruction Set Computer (RISC) core is Advanced Microprocessor Bus Architecture (AMBA), which defines a multilevel busing system with a system bus and a lower-level peripheral bus. Typically, the system bus used is an AMBA High-Speed Bus (AHB) or an Advanced System Bus (ASB) and the peripheral bus used is an Advanced Peripheral Bus (APB).

Within each microprocessor system is a memory space upon which operations are performed by one or more microprocessors of the system via, for example, an AHB bus. Each microprocessor may operate upon unique portion(s) of the memory space and/or may share portion(s) of the memory space with other microprocessor(s). Some of the operations that may be performed by a microprocessor include read operations, write operations, and execute operations.

### SUMMARY OF THE INVENTION

A system comprising at least one processor operable to perform at least one operation on a memory space in the system is provided. The system includes a bus monitor operable to monitor the at least one processor. The bus monitor includes at least one definition for specifying the at least one operation as either permissible or impermissible for a region of the memory space. The bus monitor is further operable to block the at least one processor from performing the at least one operation in response to the at least one definition specifying the at least one operation as impermissible.

A method and computer program product for controlling access to a memory space of a system that includes at least one processor operable to perform at least one operation on the memory space are also provided. The method and computer program product provide for creating at least one definition for specifying the at least one operation as either permissible or impermissible for a region of the memory space and blocking the at least one processor from performing the at least one operation in response to the at least one definition specifying the at least one operation as impermissible.

### BRIEF DESCRIPTION OF THE DRAWINGS

FIG. 1 is a process flow of a method for controlling access to a memory space of a system in accordance with an aspect of the invention.

FIG. 2 illustrates a microprocessor system according to an embodiment of the invention.

FIG. 3 depicts an implementation of a bus monitor in the microprocessor system illustrated in FIG. 2.

FIG. 4 shows one embodiment of a user interface module in the bus monitor depicted in FIG. 3.

FIG. 5 illustrates one implementation of a protection register in the user interface module shown in FIG. 4.

FIG. 6 depicts one implementation of a status register in the user interface module shown in FIG. 4.

FIG. 7 shows one implementation of an enable register in the user interface module shown in FIG. 4.

FIGS. 8-10 are various examples utilizing the protection register implementation of FIG. 5.

FIG. 11 is a block diagram of a data processing system with which embodiments of the present invention can be implemented

### DETAILED DESCRIPTION

The present invention relates generally to microprocessor systems and more particularly to access control of memory space in microprocessor systems. The following description is presented to enable one of ordinary skill in the art to make and use the invention and is provided in the context of a patent application and its requirements. Various modifications to the implementations and the generic principles and features described herein will be readily apparent to those skilled in the art. Thus, the present invention is not intended to be limited to the implementations shown, but is to be accorded the widest scope consistent with the principles and features described herein.

Within a microprocessor system comprising one or more microprocessors, it may be desirable to have an access control mechanism that is able to limit the type of operations that can be performed by the one or more microprocessors on particular regions of a memory space in the system. Since the system may include more than one microprocessor, the access control mechanism should be processor independent and permit different levels of access to be set for different microprocessors. In addition, the access control mechanism should be user configurable and easily updatable.

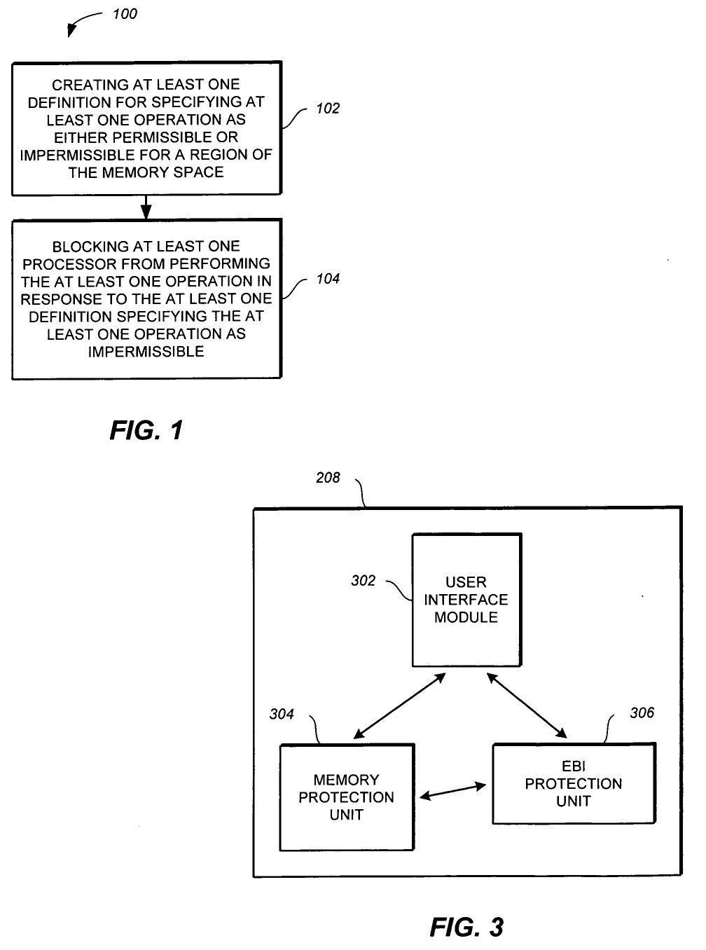

Illustrated in FIG. 1 is a process 100 for controlling access to a memory space of a system according to an aspect of the invention. The system includes at least one processor operable to perform at least one operation on the memory space. At 102, at least one definition for specifying the at least one operation as either permissible or impermissible is created for a region of the memory space. The at least one processor is then blocked from performing the at least one operation at 104 in response to the at least one definition specifying the at least one operation as impermissible.

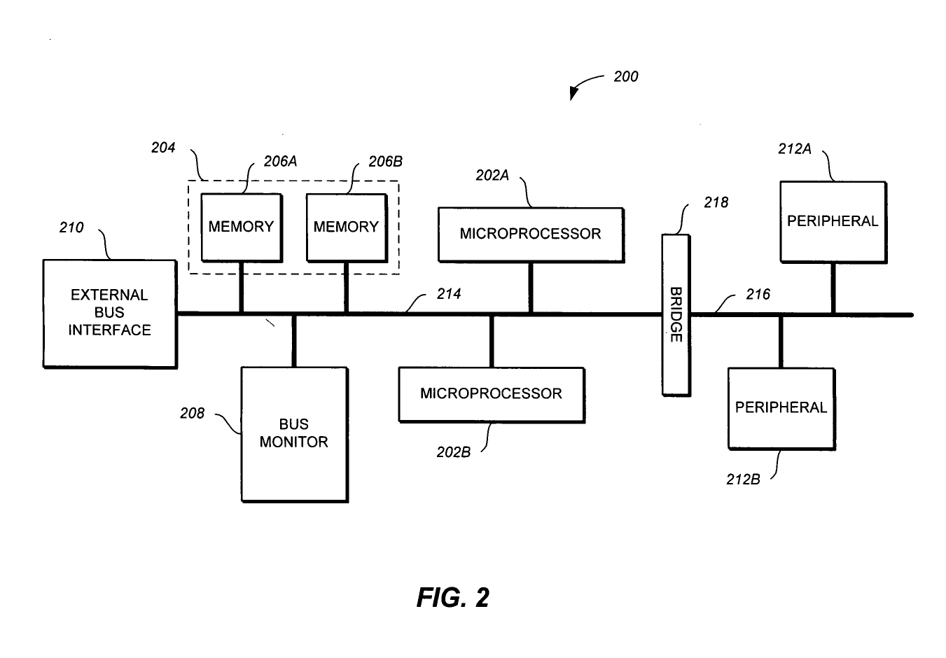

FIG. 2 depicts a microprocessor system 200 in accordance with an implementation of the invention. System 200 includes microprocessors 202A and 202B, a memory space 204 made up of two memory modules 206A and 206B (e.g., random access memory (RAM)), a bus monitor 208, an external bus interface (EBI) 210, and peripherals 212A and 212B (e.g., input devices, universal serial bus (USB) devices, etc.). Microprocessors 202A-202B, memory modules 206A-206B, bus monitor 208, and EBI 210 are interconnected via a system bus 214, such as an AMBA High-Speed Bus (AHB) or an Advanced System Bus (ASB). Peripherals 212A-212B are interconnected via a peripheral bus 216 (e.g., an Advanced Peripheral Bus (APB)), which is connected to system bus 214 via a bridge 218.

Microprocessors 202A-202B are Reduced Instruction Set Computer (RISC) microprocessors (e.g., an ARM7 or an ARM9 processor developed by ARM® Ltd.) in one implementation of the invention. In other implementations, the number of microprocessors and/or peripherals in system 200 may be increased or decreased. Additionally, the number of memory modules comprising memory space 204 may be different in other implementations.

Bus monitor 208 is a special function unit that hooks into system bus 214 and monitors various address and control signals associated with microprocessors 202A-202B (also referred to as masters) to determine whether the master seeking to perform an operation on a region of memory space 204 is allowed to perform the operation to the selected region of memory space 204. Programming of bus monitor 208 may be accomplished by firmware running on one or more of the microprocessors 202A-202B in system 200. Bus monitor 208 is coupled to a bus matrix (not shown) in another embodiment. The bus matrix is a type of memory controller that is operable to interconnect various components with system 200, which may be using different protocols.

In one implementation, the legality of the operation is determined by checking the operation against one or more definitions created for the region that is being accessed. The one or more definitions are user configurable and can be changed depending on the application. If an illegal operation (i.e., impermissible operation) is attempted, bus monitor 208 will abort the operation. In another implementation, bus monitor 208 will also set an alarm signal that can be used as an interrupt to microprocessors 202A-202B or by other security oriented modules (not shown) in system 200.

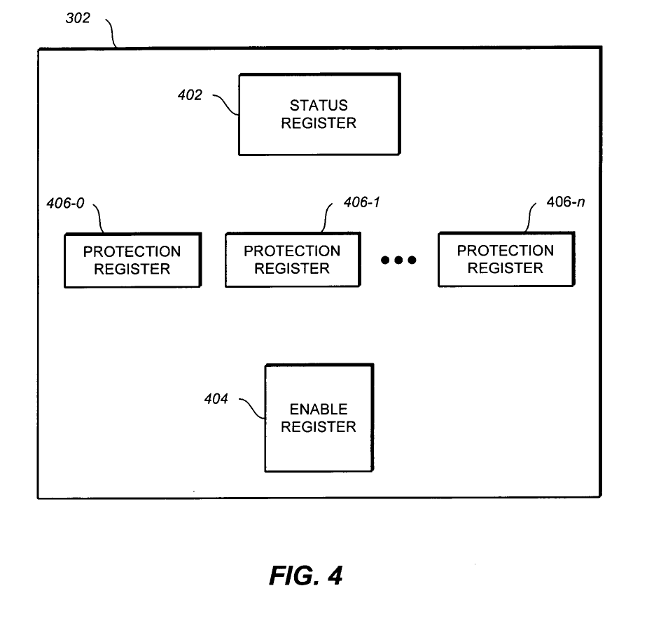

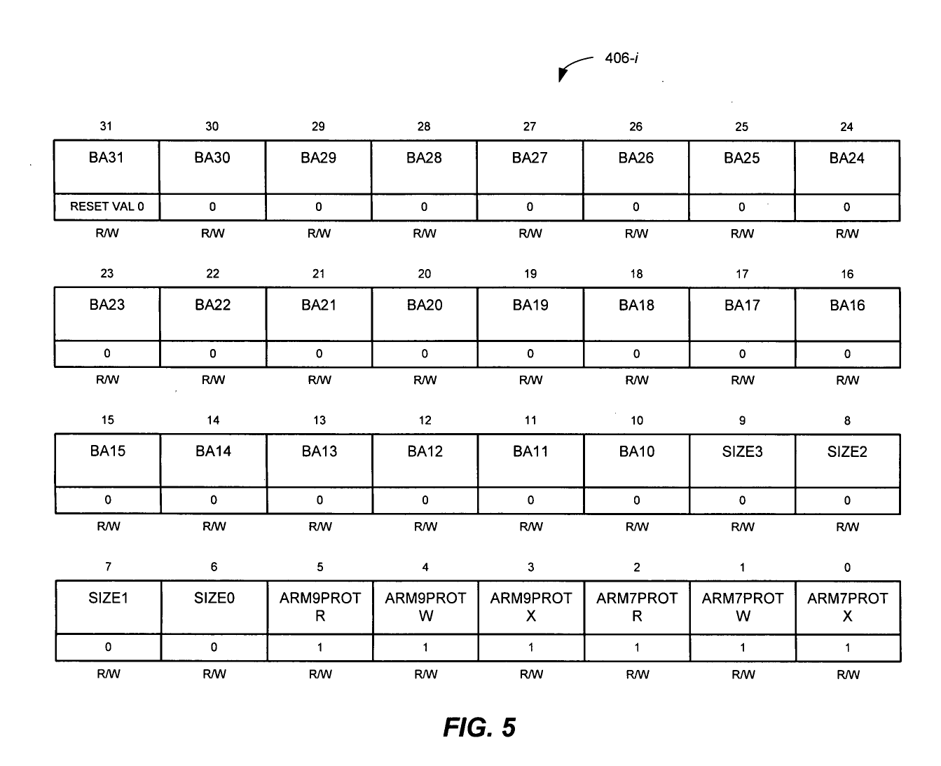

Shown in FIG. 3 is one embodiment of bus monitor 208 depicted in FIG. 2. In the embodiment, bus monitor 208 includes a user interface module 302, a memory protection unit (MPU) 304, and an EBI protection unit (EPU) 306. FIG. 4 illustrates one implementation of user interface module 302 shown in FIG. 3. In the implementation, user interface module 302 includes a status register 402, an enable register 404, and protection registers 406-0 to 406-n. Protection definitions are stored in protection registers 406-0 to 406-n. Other types of storage may be used to store the definitions in other embodiments.

Each region of memory space 204 that is protected has a corresponding protection register in the implementation. Other implementations of user interface module 302 may also include an identification register (not shown) that can be used to identify which of microprocessors 202A-202B is currently accessing memory space 204. The identification register may also be a stand-alone unit that is external to bus monitor 208.

The registers in user interface module 302 are used to configure MPU 304 in one embodiment. Access to the registers in user interface module 302 may be controlled by configuring one of the protection registers 406-0 to 406-n to include an address space of bus monitor 208. In one implementation, MPU 304 is operable to decode address, direction, and protection signals on system bus 214, then compare them to the address and protection definitions in protection registers 406-0 to 406-n.

If a violation is detected, the operation is aborted and a protection error alarm signal is generated. The alarm source (e.g., type of operation, identity of violating microprocessor, etc.) is stored in status register 402. In another embodiment, when an illegal read return data operation is intercepted, in addition to generating an abort sequence, the returned data is forced low (i.e., changed to all zeros) to provide additional protection in the event that the master (i.e., microprocessor) does not respond to the abort sequence.

EPU 306 is a non-configurable module that is operable to block opcode fetches (i.e., code executions) from EBI 210 for all masters in one implementation. In the implementation, EPU 306 is operable to monitor protection signals and EBI signals on system bus 214. If an attempt to execute code from EBI 210 is detected, the operation is aborted and a protection error alarm is generated. The alarm source is stored in status register 402.

Although the implementation defines permanent protection and non-configurable space to be EBI 210, which connects to, for instance, external memory and/or external busses, any particular space or type of operation can be permanently protected depending on the needs of the system. For example, a non-volatile memory (NVM), such as electrically erasable, programmable, read-only memory (EEPROM) or flash memory, may need to be permanently protected from specific types of operations (e.g., execute) because an unauthorized person could input code into the NVM and force the processor(s) to begin executing from the NVM, which could compromise the system.

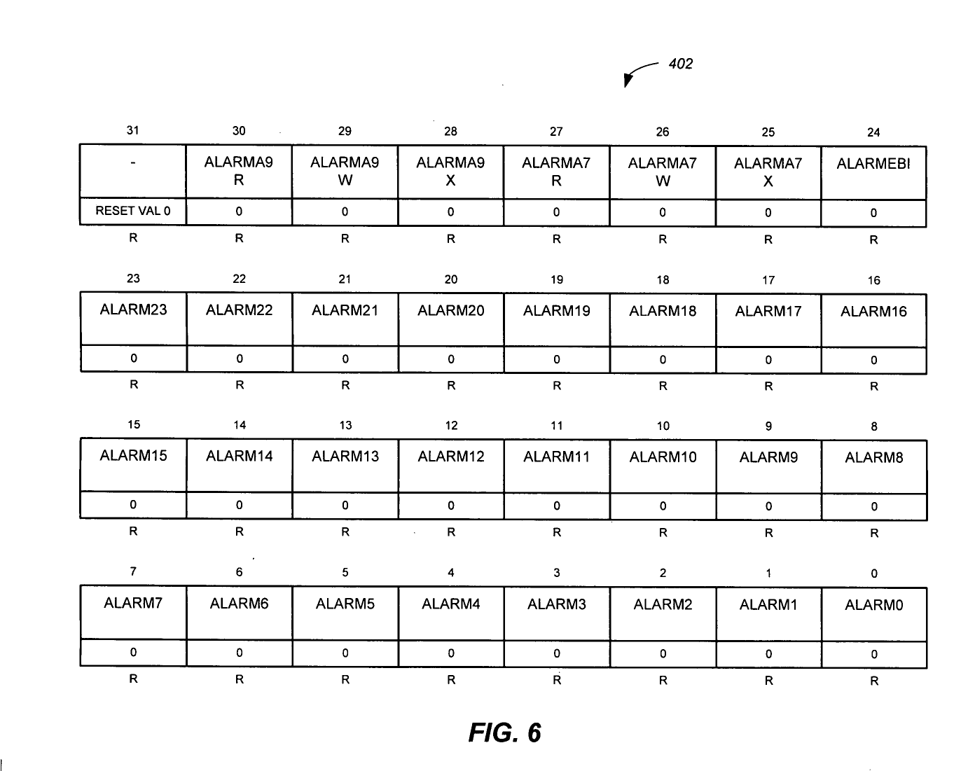

Depicted in FIG. 5 is an implementation of one of the protection registers 406-0 to 406-n illustrated in FIG. 4. In the implementation, protection register 406-i, where i=0 to n, is a 32-bit register and microprocessors 202A-202B are an ARM7 microprocessor and an ARM9 microprocessor. Protection register 406-i is used to set the protection for a region of memory space 204, which is defined by a base address (BA) and a size. Protections are defined by setting read (R), write (W), and execute (X) bits for each of the ARM7 and ARM9 microprocessors. A value of ‘1’ for a protection bit means that the operation is permitted.

Other implementations may include protection for operations in addition to or as an alternative to read, write, and execute, such as copy, swap, etc. In addition, a region defined in one protection register may overlap with a region defined in another protection register. When such an overlap occurs, the most restrictive protection is applied in one embodiment. Further, the permissions defined may be applicable to all user and privilege modes.

Bits 0 to 2 [2:0] of protection register 406-i indicate that read, write, and execute operations are permitted for the ARM7 microprocessor. Bits [5:3] indicate that read, write, and execute operations are also permitted for the ARM9 microprocessor. Bits [9:6] indicate the region size to be protected starting at the base address. In Table 1, a list of the region sizes available in one implementation of the invention are shown along with each size's corresponding bit-representation and least significant byte (LSB). For example, if the region size is 1 kilobytes (KB), bits [9:6] will read 0000. Other implementations may include different region sizes.

TABLE 1
Region Sizes

| Size Bits | Region Size | | LSB |
|---|---|---|---|
| 0000 | 1 | KBytes | 10 |
| 0001 | 2 | KBytes | 11 |
| 0010 | 4 | KBytes | 12 |
| 0011 | 8 | KBytes | 13 |
| 0100 | 16 | KBytes | 14 |
| 0101 | 32 | KBytes | 15 |
| 0110 | 64 | KBytes | 16 |
| 0111 | 128 | KBytes | 17 |
| 1000 | 256 | KBytes | 18 |
| 1001 | 512 | KBytes | 19 |
| 1010 | 1 | MBytes | 20 |
| 1011 | 2 | MBytes | 21 |
| 1100 | 4 | MBytes | 22 |
| 1101 | 256 | MBytes | 28 |
| 1110 | 512 | MBytes | 29 |
| 1111 | 1 | GBytes | 30 |

The base address of the region to be protected is stored in bits [31:10]. In one embodiment, the size of a region does not dictate a location for the region, i.e., the base address of the region. For example, if a 4 KB region is being defined for protection, the region need not begin at 0 KB, 4 KB, 8 KB, 12 KB, etc., and can instead begin at any location, such as 3 KB. In another embodiment, the base address of a region is a multiple of the smallest region size available. For instance, if the region sizes are based on Table 1, then the base address will be a multiple of 1 KB.

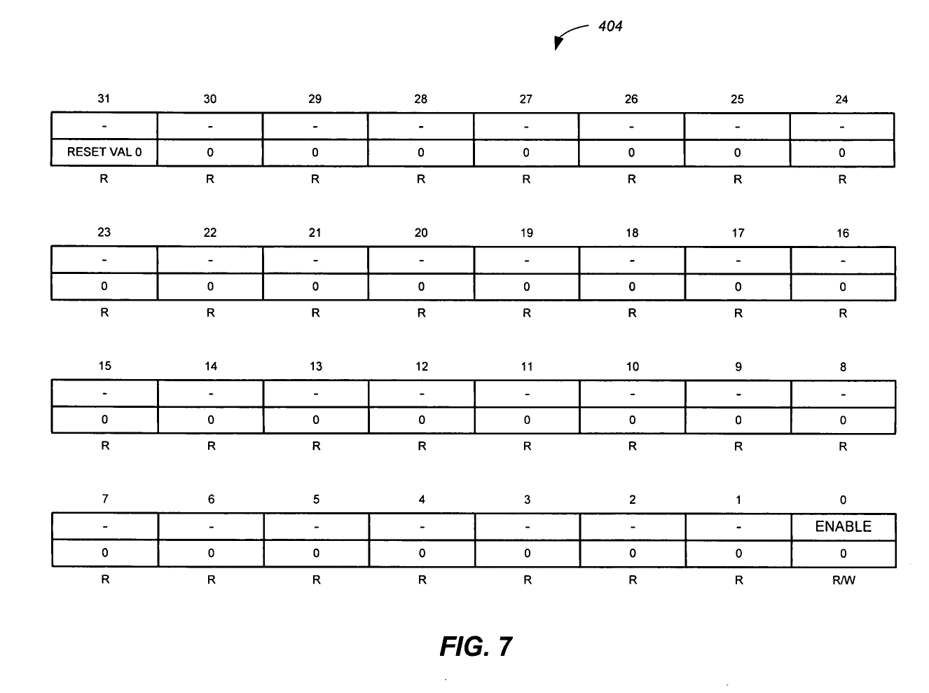

FIG. 6 shows an implementation of status register 402 illustrated in FIG. 4. In the implementation, status register 402 is also a 32-bit register. Bits [30:28] indicate the type of illegal memory access made by the ARM9 microprocessor, e.g., read, write, or execute. Bits [27:25] indicate the type of illegal memory access made by the ARM7 microprocessor. As with protection register 406-i in FIG. 5, there may be other types of operation that are protected in other embodiments. Additionally, the ARM7 and ARM9 microprocessors may be replaced by other types of processors.

Bit [24] indicates an illegal attempt to execute code from EBI 210. Each of bits [23:0] corresponds to one protection register and is used to indicate violation of the protection definition in the respective protection register. In the implementation, twenty-four protection registers are included in user interface module 302. Other implementations may include more or less protection registers.

As an example, if the definition in protection register 406-1 is violated by microprocessor ARM7 attempting a write operation, bits [1] and [26] will be set to “1.” Thus, status register 402 can be used to determine the source and type of memory access violation. If a memory access violates the rules/definitions of multiple protection registers 406-0 to 406-n, multiple alarm bits will be set in one embodiment.

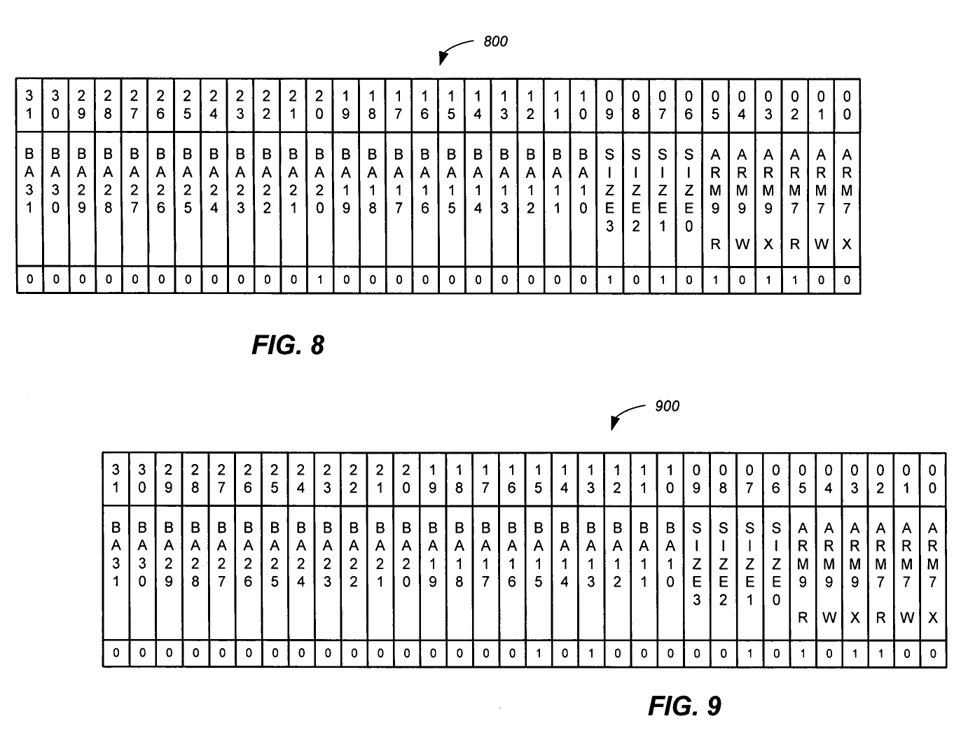

Illustrated in FIG. 7 is an embodiment of enable register 404 in FIG. 4. Enable register 404 controls the use of protection registers 406-0 to 406-n. In one implementation, all of protection registers 406-0 to 406-n are enabled (e.g., bit value set to “1”) or disabled (e.g., bit value set to “0”) together. In another implementation, each protection register can be independently disabled or enabled. Since EBI 210 has been designated for permanent protection, that protection cannot be disabled and has no corresponding bit in enable register 404. In the embodiment, writing any value to enable bit [0] clears status register 402.

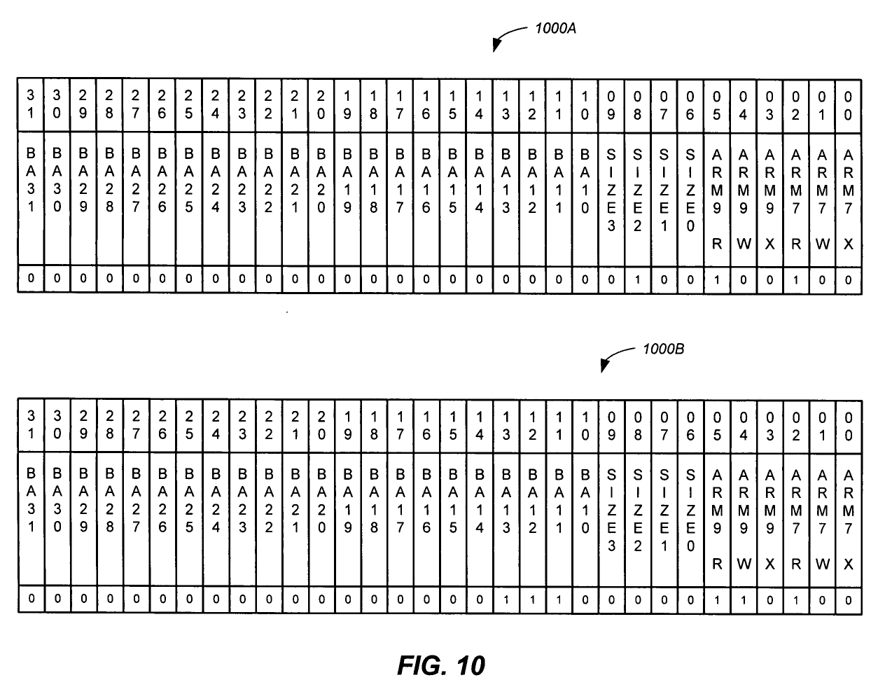

FIGS. 8-10 show various examples utilizing the protection register implementation in FIG. 5. In FIG. 8, a 512 KB flash block located at hex 0x00100000 and another located at hex 0x00180000 form a logical 1 megabyte (MB) flash block. To protect this 1 MB region, the region is defined starting at the base address of the first 512 KB flash block and stretching over the second 512 KB flash block. Base address bits [31:10] in protection register 800 are set to binary 01 0000 0000 00, which corresponds to the base address of the 1 MB region. In accordance with Table 1 above, the size bits [9:6] are set to 1010, which corresponds to 1 MB. In the example, the ARM7 microprocessor only has permission to perform read operations on the region and the ARM9 microprocessor has permission to perform read and execute operations on the region.

Protection register 900 in the example of FIG. 9 defines protection for a 4 KB region that starts at a base address of hex 0x0000A000, which is the same as decimal 40960 or 40 KB. Base address bits [31:10] in register 900 are set to binary 00 0000 1010 00 corresponding to the base address. Size bits [9:6] are set to 0010, which is 4 KB in accordance with Table 1 above. Permissions for ARM9 and ARM7 microprocessors are set to 101 and 100, which is the same as the example in FIG. 8, i.e., ARM9 can perform read/execute operations and ARM7 can perform read-only operations.

The example in FIG. 10 includes two protection registers 1000A and 1000B that protect overlapping regions. Protection register 1000A includes a definition that protects a 16 KB region starting at base address 0x00000000 (i.e., 0 KB). Hence, base address bits [31:10] are set to binary 00 0000 0000 00 and size bits [9:6] are set to 0100. ARM7 and ARM9 microprocessors are permitted to perform read-only operations under the protection definition in register 1000A since bits [2:0] and [5:3] are both set to 100.

Another 16 KB region is defined in protection register 1000B. Since the second 16 KB region starts at base address 0x00001C00 (i.e., 14 KB), base address bits [31:10] are set to binary 00 0000 0111 00. For this second 16 KB region, ARM7 is still limited to read-only operations, but ARM9 is allowed to perform read/write operations.

If the most restrictive protections are applied for overlapping regions, then for the 2 KB overlap between the first region defined in register 1000A and the second region defined in register 1000B from address 14 KB to 16 KB, the ARM9 microprocessor will be limited to read-only operations as defined in register 1000A since it is more restrictive than register 1000B. Hence, if the ARM9 microprocessor attempts to perform an operation other than a read in the 2 KB overlap region, an alarm condition will be raised and will show up in status register 402 in the bit associated with register 1000A.

Tables 2-7 are examples of various signals monitored by bus monitor 208 and their descriptions in accordance with one implementation of the invention. In the implementation, system bus 214 is an AHB and peripheral bus 216 is an APB.

TABLE 2
AHB Signals

| Pin | Direction | Description |
|---|---|---|
| hclk | Input | AHB system clock |
| Hresetn | Input | Reset (active low) |
| haddr_ml0_arm946[31:0] | Input | Address Bus from Arm9 processor |
| haddr_ml1_arm7tdmi[31:0] | Input | Address Bus from Arm7 processor |
| hwrite_ml0_arm946[31:0] | Input | Transfer Direction |
| | | HIGH = write transfer; LOW = read transfer |
| hwrite_ml1_arm7tdmi[31:0] | Input | Transfer Direction |
| hprot_ml0_arm946[3:0] | Input | Protection Control |
| | | Indicates if transfer is an opcode fetch or data access. |
| | | Also indicates if the transfer is a privileged mode |
| | | access or user access. |
| hprot_ml1_arm7tdmi[3:0] | Input | Protection Control |
| hready_from_ml0_arm946 | Input | hready from matrix intended for Arm9 processor |
| hready_from_ml1_arm7tdmi | Input | hready from matrix intended for Arm7 processor |
| hrdata_from_matrix_to_ml0[31:0] | Input | hrdata from maxtrix intended for Arm9 processor |
| hrdata_from_matrix_to_ml1[31:0] | Input | hrdata from maxtrix intended for Arm7 processor |
| htrans_ml0_arm946[1:0] | Input | Transfer status from Arm9 processor to matrix (slave) |
| htrans_ml0_arm7tdmi[1:0] | Input | Transfer status from Arm7 processor to matrix (slave) |
| busmon_ml0_hresp[1:0] | Output | Abort signal back to Arm9 processor (hold for 2 |
| | | cycles) |
| busmon_ml1_hresp[1:0] | Output | Abort signal back to Arm7 processor (hold for 2 |
| | | cycles) |
| busmon_hready_from_ml0 | Output | Wait state - LOW in first cycle of abort; HIGH in |
| | | second cycle of abort |
| busmon_hready_from_ml1 | Output | Wait state - LOW in first cycle of abort; HIGH in |
| | | second cycle of abort |
| busmon_htrans_to_matrix_from_ml0[1:0] | Output | Transfer status to matrix (set to IDLE during |
| | | violation) |
| busmon_htrans_to_matrix_from_ml1[1:0] | Output | Transfer status to matrix (set to IDLE during |
| | | violation) |
| busmon_hrdata_from_maxtrix_to_ml0[31:0] | Output | Read data back to Arm9 (driven LOW during read |
| | | and opcode fetch violations) |
| busmon_hrdata_from_maxtrix_to_ml1[31:0] | Output | Read data back to Arm7 (driven LOW during read |
| | | and opcode fetch violations) |

TABLE 3
APB Signals

| Pin | Direction | Description |
|---|---|---|
| config_clock | Input | User Register Configuration Clock |
| paddr | Input | APB Address Bus |
| psel | Input | APB Peripheral Decode Select Signal |
| pwrite | Input | APB Register Access Direction |
| | | (write or read) |
| pwdata | Input | APB Register Write Data |
| prdata | Output | APB Register Read Data |

TABLE 4
Non-AHB/APB Signals

| Pin | Direction | Description |
|---|---|---|
| alarm_out | Output | Illegal memory access |
| | | (protection error) detected |
| scan_test_mode | Input | ATPG mode enable |
| test_se | Input | Scan Enable |
| test_si | Input | Scan In |
| test_so | Output | Scan Out |

TABLE 5
‘hresp’ signal

| hresp[1] | hresp[0] | Description |
|---|---|---|
| 0 | 0 | Okay |
| 0 | 1 | Error |
| 1 | 0 | Retry |
| 1 | 1 | Split |

TABLE 6
‘htrans’ signal

| htrans[1] | htrans[0] | Description |
|---|---|---|
| 0 | 0 | Idle |
| 0 | 1 | Busy |
| 1 | 0 | Nonseq |
| 1 | 1 | Seq |

TABLE 7
‘hprot’ signal

| hprot[3] | hprot[2] | hprot[1] | hprot[0] | Description |
|---|---|---|---|---|
| — | — | — | 0 | Opcode fetch |
| — | — | — | 1 | Data access |
| — | — | 0 | — | User access |
| — | — | 1 | — | Privileged access |
| — | 0 | — | — | Not bufferable |
| — | 1 | — | — | Bufferable |
| 0 | — | — | — | Not cacheable |
| 1 | — | — | — | Cacheable |

In one implementation, if a protection error alarm condition (i.e., illegal memory access) is detected, bus monitor 208 will force ‘hresp[1:0]’ signals for the appropriate master(s) to 2′b01 (error) for two cycles. During the first of the two cycles, ‘hready’ will be LOW (e.g., 0). On the second cycle ‘hready’ will be HIGH (e.g., 1). Bus monitor 208 will also force ‘htrans[1:0]’ signals to 2′b00 (busy) for the appropriate master(s) to prevent a slave from responding to the illegal request. In addition, bus monitor 208 will force ‘hrdata[31:0]’ signals for the violating master(s) to LOW to prevent the master(s) from seeing protected data. Bus monitor 208 may only look at ‘hprot[1] and ‘hprot[0]’ to determine whether an opcode fetch is occurring and to determine what mode the master is operating in (e.g., user or privileged).

The invention can take the form of an entirely hardware embodiment, an entirely software embodiment, or an embodiment containing both hardware and software elements. In one aspect, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

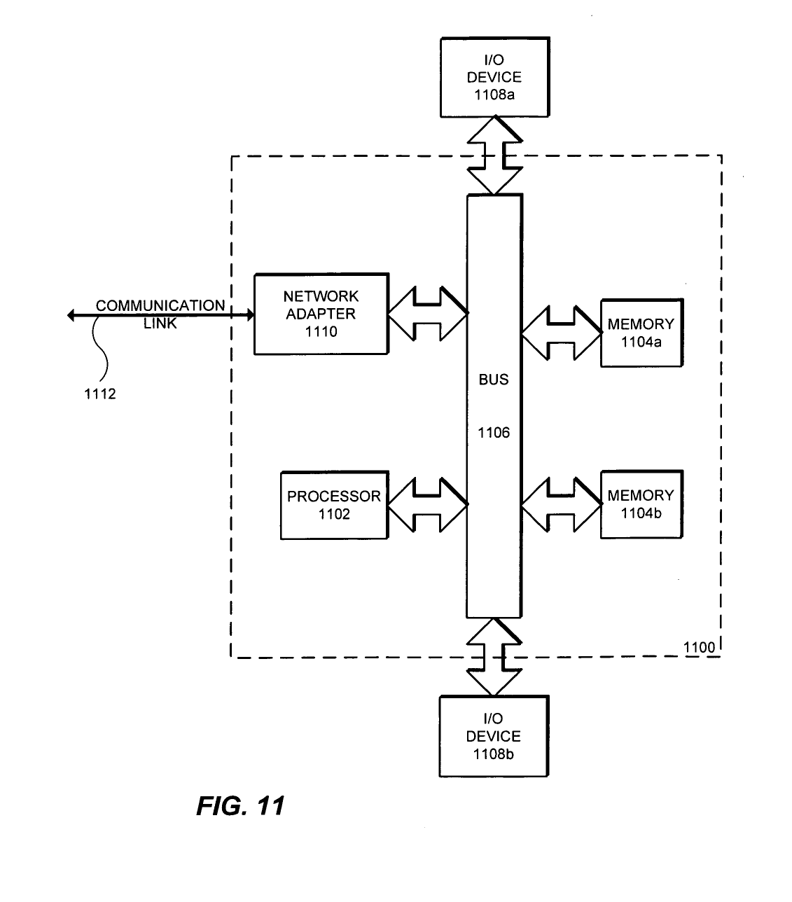

FIG. 11 shows a data processing system 1100 suitable for storing and/or executing program code. Data processing system 1100 includes a processor 1102 coupled to memory elements 1104a-b through a system bus 1106. In other embodiments, data processing system 1100 may include more than one processor and each processor may be coupled directly or indirectly to one or more memory elements through a system bus.

Memory elements 1104a-b can include local memory employed during actual execution of the program code, bulk storage, and cache memories that provide temporary storage of at least some program code in order to reduce the number of times the code must be retrieved from bulk storage during execution. As shown, input/output or I/O devices 1108a-b (including, but not limited to, keyboards, displays, pointing devices, etc.) are coupled to data processing system 1100. I/O devices 1108a-b may be coupled to data processing system 1100 directly or indirectly through intervening I/O controllers (not shown).

In the embodiment, a network adapter 1110 is coupled to data processing system 1100 to enable data processing system 1100 to become coupled to other data processing systems or remote printers or storage devices through a communication link 1112. Communication link 1112 can be a private or public network. Modems, cable modems, and Ethernet cards are just a few of the currently available types of network adapters.

Through the use of a bus monitor, access control of the memory space of a microprocessor system is provided. The use of protection definitions provides a means to protect arbitrary regions of memory from one or more processors without being restricted to particular locations based oh the size of the region to be protected. Since the bus monitor is processor-independent, individual memory access control for multiple processors is made possible.

Processors within a system may also be able to share the same source code if an identity register is included because branch execution can be based on results of an identity register read. A means to permanently block certain types of access (e.g., executing code from external memory) to areas of the memory space is also provided.

Various implementations for access control of memory space in microprocessor systems have been described. Nevertheless, one of ordinary skill in the art will readily recognize that various modifications may be made to the implementations, and any variations would be within the spirit and scope of the present invention. For example, the above-described process flows are described with reference to a particular ordering of process actions. However, the ordering of many of the described process actions may be changed without affecting the scope or operation of the invention. Accordingly, many modifications may be made by one of ordinary skill in the art without departing from the spirit and scope of the following claims.

What is claimed is:

1. A system comprising:
a plurality of processors operable to perform at least one operation on a memory space in the system; and
a bus monitor operable to monitor the plurality of processors, the bus monitor including at least one definition specifying, for a region of the memory space, the at least one operation as either permissible or impermissible for each of the plurality of processors;
wherein the bus monitor is further operable to block at least one of the plurality of processors from performing the at least one operation on the region of memory space responsive to the at least one definition specifying the at least one operation as impermissible for the at least one processor.

2. The system of claim 1, wherein the bus monitor is further operable to generate an alarm signal in response to the at least one processor attempting to perform the at least one operation on the region when the at least one definition specifies the at least one operation as impermissible for the at least one processor.

3. The system of claim 1, wherein the at least one definition is user configurable.

4. The system of claim 1, wherein a size of the region does not dictate a location for the region.

5. The system of claim 1, wherein the bus monitor is further operable to permanently block one or more of the plurality of processors from performing one or more operations on one or more regions of the memory space.

6. The system of claim 1, wherein the at least one definition specifies the at least one operation as permissible for one of the plurality of processors and impermissible for another of the plurality of processors.

7. The system of claim 1, wherein the bus monitor is further operable to block at least another of the plurality of processors from performing the at least one operation on the region in response to the at least one definition specifying the at least one operation as impermissible for the at least one other processor.

8. The system of claim 7, further comprising:
an identification register in communication with the bus monitor, the identification register being operable to identify which of the at least one processor and the at least one other processor is attempting to perform the at least one operation on the region.

9. The system of claim 8, wherein the identification register is part of the bus monitor.

10. The system of claim 1, wherein the bus monitor further includes at least one other definition specifying, for another region of the memory space, the at least one operation as either permissible or impermissible for each of the plurality of processors.

11. The system of claim 10, wherein when a portion of the region specified in the at least one definition is within the other region specified in the at least one other definition, the definition with a more restrictive permission is applied to the portion for each of the plurality of processors.

12. A method for controlling access to a memory space of a system, wherein the system includes a plurality of processors operable to perform at least one operation on the memory space, the method comprising:
creating at least one definition specifying, for a region of the memory space, the at least one operation as either permissible or impermissible for each of the plurality of processors; and
blocking at least one of the plurality of processors from performing the at least one operation on the region of memory space responsive to the at least one definition specifying the at least one operation as impermissible for the at least one processor.

13. The method of claim 12, further comprising:
generating an alarm signal in response to the at least one processor attempting to perform the at least one operation on the region when the at least one definition specifies the at least one operation as impermissible for the at least one processor.

14. The method of claim 12, wherein the at least one definition is user configurable.

15. The method of claim 12, wherein a size of the region does not dictate a location for the region.

16. The method of claim 12, further comprising:
permanently blocking one or more of the plurality of processors from performing one or more operations on one or more regions of the memory space.

17. The method of claim 12, wherein the at least one definition specifies the at least one operation as permissible for one of the plurality of processors and impermissible for another of the plurality of processors.

18. The method of claim 12, further comprising:
blocking at least another of the plurality of processors from performing the at least one operation on the region in response to the at least one definition specifying the at least one operation as impermissible for the at least one other processor.

19. The method of claim 18, further comprising:
identifying which of the at least one processor and the at least one other processor is attempting to perform the at least one operation on the region.

20. The method of claim 12, further comprising:
creating at least one other definition specifying, for another region of the memory space, the at least one operation as either permissible or impermissible for each of the plurality of processors.

21. The method of claim 20, wherein when a portion of the region specified in the at least one definition is within the other region specified in the at least one other definition, the definition with a more restrictive permission is applied to the portion for each of the plurality of processors.

22. A computer program product comprising a computer readable medium, the computer readable medium including a computer readable program for controlling access to a memory space of a system, the system including a plurality of processors operable to perform at least one operation on the memory space, wherein the computer readable program when executed on a computer causes the computer to:
create at least one definition specifying, for a region of the memory space, the at least one operation as either permissible or impermissible for each of the plurality of processors; and
block at least one of the plurality of processors from performing the at least one operation on the region of memory space responsive to the at least one definition specifying the at least one operation as impermissible for the at least one processor.

23. The computer program product of claim 22, wherein the computer readable program when executed on the computer further causes the computer to:
generate an alarm signal in response to the at least one processor attempting to perform the at least one operation on the region when the at least one definition specifies the at least one operation as impermissible for the at least one processor.

24. The computer program product of claim 22, wherein the at least one definition is user configurable.

25. The computer program product of claim 22, wherein a size of the region does not dictate a location for the region.

26. The computer program product of claim 22, wherein the computer readable program when executed on the computer further causes the computer to:
permanently block one or more of the plurality of processors from performing one or more operations on one or more regions of the memory space.

27. The computer program product of claim 22, wherein the at least one definition specifies the at least one operation as permissible for one of the plurality of processors and impermissible for another of the plurality of processors.

28. The computer program product of claim 22, wherein the computer readable program when executed on the computer further causes the computer to:
block at least another of the plurality of processors from performing the at least one operation on the region in response to the at least one definition specifying the at least one operation as impermissible for the at least one other processor.

29. The computer program product of claim 28, wherein the computer readable program when executed on the computer further causes the computer to:
identify which of the at least one processor and the at least one other processor is attempting to perform the at least one operation on the region.

30. The computer program product of claim 22, wherein the computer readable program when executed on the computer further causes the computer to:
create at least one other definition specifying, for another region of the memory space, the at least one operation as either permissible or impermissible for each of the plurality of processors.

31. The computer program product of claim 30, wherein when a portion of the region specified in the at least one definition is within the other region specified in the at least one other definition, the definition with a more restrictive permission is applied to the portion for each of the plurality of processors.
